(19) United States
(12) Patent Application Publication
(10) Pub. No.: US 2010/0329228 A1
(43) Pub. Date: Dec. 30, 2010

(54) DIGITAL BROADCAST RETRANSMISSION SYSTEM, DIGITAL BROADCAST RETRANSMISSION METHOD, PACKET CONVERTING APPARATUS, AND FREQUENCY CONVERTING APPARATUS

(76) Inventor: MASAHIKO KAMIYAMA, Tokyo (JP)

Correspondence Address: Mr. Jackson Chen, 6535 N. STATE HWY 161, IRVING, TX, 75039, US

(21) Appl. No.: 12/796,728

(22) Filed: Jun. 9, 2010

(30) Foreign Application Priority Data
Jun. 29, 2009 (JP) 2009-153634

(51) Int. Cl. H04B 7/208; H04L 27/28; H04L 23/02

(52) U.S. Cl. 370/344; 375/260; 375/265

(57) ABSTRACT

A digital broadcast retransmission system of the present invention includes: a packet converting apparatus that receives a radio frequency signal broadcasted from a digital broadcasting apparatus, demodulates the radio frequency signal to extract transmission-path-encoded transmission path encoding information from the radio frequency signal, converts the transmission path encoding information into a packet, and transmits the packet to a network; and a frequency converting apparatus that receives the packet from the packet converting apparatus through the network, extracts the transmission path encoding information from the packet, modulates the transmission path encoding information to generate a radio frequency signal, and transmits the radio frequency signal to a digital broadcast receiving apparatus.

This application is based upon and claims the benefit of priority from Japanese patent application No. 2009-153634, filed on Jun. 29, 2009, the disclosure of which is incorporated herein in its entirety by reference.

### BACKGROUND OF THE INVENTION

1. Technical Field

The present invention relates to a conversion method of a signal in a system for retransmitting a digital broadcast using an Internet protocol.

2. Background Art

Terrestrial analog broadcasting is scheduled to end in 2011, and the broadcasting will be shifted to the terrestrial digital broadcasting. Therefore, all areas need to be able to receive the terrestrial digital broadcasting. However, there are still difficult-to-view areas where radio waves are hard to receive. A technique for digital broadcast retransmission that uses an IP (Internet Protocol) to retransmit the terrestrial digital broadcast is used to provide terrestrial digital broadcasting to the difficult-to-view areas.

An encoding process in a typical broadcasting apparatus for terrestrial digital broadcasting will be described.

The broadcasting apparatus for terrestrial digital broadcasting applies information source encoding to the video and audio signals, and to the data to be broadcast. MPEG-2 (Moving Picture Experts Group phase 2) is adopted as an information source encoding system for terrestrial digital broadcasts. The broadcasting apparatus encodes the video and audio signals, and the data to be broadcast into a TS (Transport Stream) packet of MPEG-2. The broadcasting apparatus then converts the TS packet of MPEG-2 into a broadcast TS (Transport Stream) packet including a multiple-frame structure of a terrestrial digital television signal.

The broadcasting apparatus then applies transmission path encoding to the information-source-encoded information in accordance with the bandwidth of the transmission path, noise characteristics, etc. An OFDM (Orthogonal Frequency Division Multiplexing) modulation system is adopted as a transmission path encoding system for terrestrial digital broadcasting. The broadcasting apparatus applies processing to the broadcast TS packet, such as Reed-Solomon coding (external coding), hierarchical division, energy diffusion, byte interleaving, convolutional coding (internal coding), hierarchical synthesis, time interleaving, and frequency interleaving. The broadcasting apparatus attaches a pilot signal and a TMCC (Transmission and Multiplexing Configuration Control) signal to the processed signal to generate an OFDM frame. The broadcasting apparatus applies IFFT (Inverse Fast Fourier Transform) to the OFDM frame and further attaches a guard interval to generate an OFDM signal.

The broadcasting apparatus converts the OFDM signal into an analog signal and further converts the frequency to generate and output an RF (Radio Frequency) signal which is a radio frequency signal of a terrestrial digital broadcast.

The RF signal of the terrestrial digital broadcast outputted from the broadcasting apparatus is transmitted to each household and inputted to a terrestrial digital tuner or a terrestrial digital compatible TV. This allows the user to view terrestrial digital broadcasting.

JP2008-211587A discloses a technique for retransmitting a terrestrial digital broadcast. In the system disclosed in JP2008-211587A, a transmitting apparatus is installed on a broadcaster, and an IP/RF converting apparatus is installed on a receiver. The transmitting apparatus is an apparatus that converts an RF signal of a terrestrial digital broadcast into an IP packet. The transmitting apparatus separates an RF signal received from the broadcasting apparatus into a broadcast TS packet to convert the RF signal into an IP packet for each broadcast TS packet, and transmits the IP packet to an IP network. The IP/RF converting apparatus extracts the broadcast TS packet from the IP packet received from the transmitting apparatus, generates an OFDM signal from the extracted broadcast TS packet, and regenerates the RF signal of the terrestrial digital broadcast.

The IP/RF converting apparatus of JP2008-211587A is characterized by extracting a synchronous clock from the received broadcast TS packet to generate an OFDM signal based on the synchronous clock.

FIG. 1 is a process flow diagram showing processes within the system disclosed in JP2008-211587A.

As shown in FIG. 1, the transmitting apparatus of the system disclosed in JP2008-211587A applies analog/digital conversion (hereinafter, called A/D conversion) to an RF signal of a terrestrial digital broadcast and extracts an OFDM signal OFDM-modulated by the terrestrial digital broadcasting apparatus. The transmitting apparatus then applies OFDM demodulation to the extracted OFDM signal to extract a broadcast TS packet. The transmitting apparatus converts the OFDM signal into an IP packet for each broadcast TS packet and transmits the IP packet to an IP network.

The IP/RF converting apparatus extracts the broadcast TS packet from the IP packet received from the transmitting apparatus. The IP/RF converting apparatus then applies OFDM modulation to the extracted broadcast TS packet to regenerate the OFDM signal. The IP/RF converting apparatus applies digital/analog conversion (hereinafter, called D/A conversion) and frequency conversion to the OFDM signal to generate an RF signal of the terrestrial digital broadcast.

In the technique described in JP2008-211587A, the hardware size of the transmitter is large due to the transmitting apparatus, and the hardware size of the receiver is large due to the IP/RF converting apparatus. Furthermore, the amount of time, until the terrestrial digital broadcast that is broadcasted from the broadcasting apparatus is reproduced, is long because of the processes by the transmitting apparatus and the IP/RF converting apparatus.

### SUMMARY

An exemplary object is to provide a technique for realizing a system of quickly retransmitting a digital broadcast using an Internet protocol in which the hardware size of a packet converting apparatus and a frequency converting apparatus is small.

To attain the object, an exemplary aspect of the present invention provides a digital broadcast retransmission system comprising: a packet converting apparatus that receives a radio frequency signal broadcasted from a digital broadcasting apparatus, demodulates the radio frequency signal to extract transmission-path-encoded transmission path encoding information from the radio frequency signal, converts the transmission path encoding information into a packet, and transmits the packet to a network; and a frequency converting apparatus that receives the packet from the packet converting apparatus through the network, extracts the transmission path encoding information from the packet, modulates the transmission path encoding information to generate a radio frequency signal, and transmits the radio frequency signal to a digital broadcast receiving apparatus.

To attain the object, an exemplary aspect of the present invention provides a digital broadcast retransmission method comprising: a packet converting apparatus receiving a radio frequency signal broadcasted from a digital broadcasting apparatus and demodulating the radio frequency signal to extract transmission-path-encoded transmission path encoding information from the radio frequency signal; the packet converting apparatus converting the transmission path encoding information into a packet and transmitting the packet to a network; a frequency converting apparatus receiving the packet from the packet converting apparatus through the network and extracting the transmission path encoding information from the packet; the frequency converting apparatus modulating the transmission path encoding information to generate a radio frequency signal; and the frequency converting apparatus transmitting the radio frequency signal to a digital broadcast receiving apparatus.

To attain the object, an exemplary aspect of the present invention provides a packet converting apparatus comprising: radio frequency signal receiver for receiving a radio frequency signal broadcasted from a digital broadcasting apparatus and demodulating the radio frequency signal to extract transmission-path-encoded transmission path encoding information from the radio frequency signal; and packet transmitter for converting the transmission path encoding information into a packet and transmitting the packet to a network.

To attain the object, an exemplary aspect of the present invention provides a frequency converting apparatus that converts transmission path encoding information transmission-path-encoded by a digital broadcasting apparatus into a packet and that connects to a packet converting apparatus that transmits the packet to a network, the frequency converting apparatus comprising: packet receiver for receiving the packet from the packet converting apparatus through the network and extracting the transmission path encoding information from the packet; radio frequency signal generator for modulating the transmission path encoding information to generate a radio frequency signal; and transmitter for transmitting the radio frequency signal to as digital broadcast receiving apparatus.

According to the present invention, a system of quickly retransmitting a digital broadcast using an Internet protocol can be realized in which the hardware size of a packet converting apparatus and a frequency converting apparatus is small.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a process flow diagram showing processes within the system disclosed in JP2008-211587A;

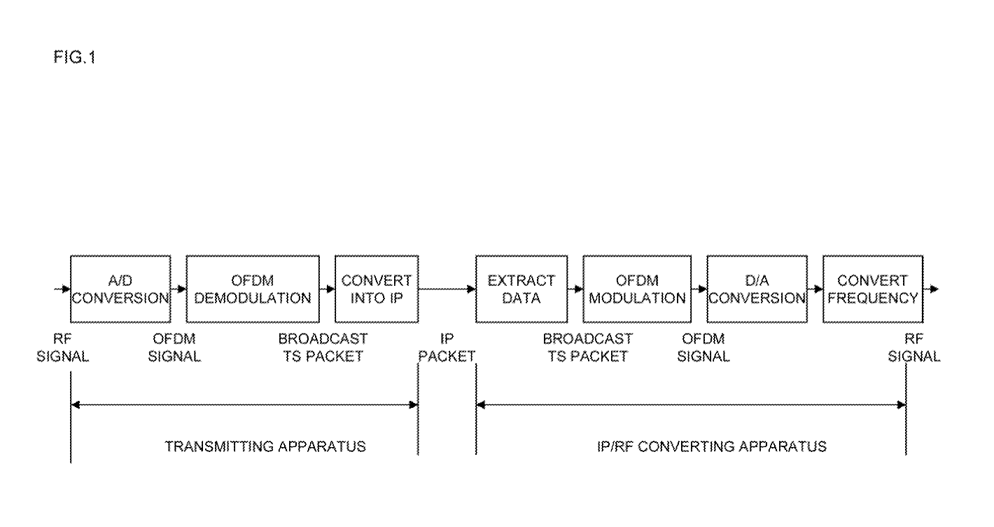

FIG. 2 is a process flow diagram showing processes within a digital broadcast retransmission system of exemplary embodiments;

FIG. 3 is a block diagram showing a configuration of the digital broadcast retransmission system of a first exemplary embodiment;

FIG. 4 is a block diagram showing a configuration of a packet converting apparatus of the first exemplary embodiment;

FIG. 5 is a block diagram showing a configuration of a frequency converting apparatus of the first exemplary embodiment;

FIG. 6 is a flow chart showing a process by which the packet converting apparatus shown in FIG. 4 converts the RF signal of the terrestrial digital broadcast into an IP packet; and

FIG. 7 is a flow chart showing a process by which the frequency converting apparatus shown in FIG. 5 converts an IP packet received from the packet converting, apparatus into an RF signal of the terrestrial digital broadcast.

### EXEMPLARY EMBODIMENT

The present invention will now be described in detail with reference to the drawings.

### First Exemplary Embodiment

A digital broadcast retransmission system of an exemplary embodiment includes a packet converting apparatus that converts an RF signal, which is a radio frequency signal of a terrestrial digital broadcast, into an IP packet and a frequency converting apparatus that regenerates an RF signal of the terrestrial digital broadcast from the IP packet. The packet converting apparatus extracts transmission-path-encoded information from the RF signal of the digital broadcast received from the broadcasting apparatus of the digital broadcast, converts the transmission-path-encoded information into an IP packet without restoring information-source-encoded information, and transmits the information to an IP network. The frequency converting apparatus extracts the transmission-path-encoded information from the IP packet received from the packet converting apparatus and regenerates the RF signal of the terrestrial digital broadcast from the extracted information. As a result, the packet converting apparatus can skip the decoding process of the transmission path encoding, and the frequency converting apparatus can skip the coding process of the transmission path encoding.

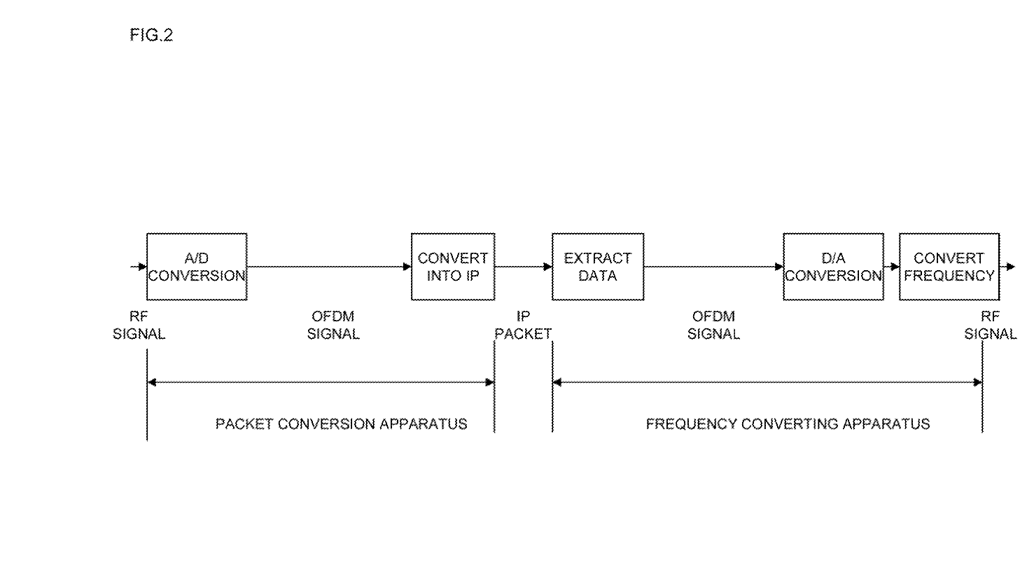

FIG. 2 is a process flow diagram showing processes within the digital broadcast retransmission system of the exemplary embodiment.

As shown in FIG. 2, the packet converting apparatus of the digital broadcast retransmission system of the exemplary embodiment applies A/D conversion to an RF signal of the terrestrial digital broadcast to extract an OFDM signal, converts the extracted OFDM signal into an packet, and transmits the packet to an IP network.

The frequency converting apparatus extracts the OFDM signal from the IP packet received from the packet converting apparatus and applies D/A conversion and frequency conversion to the extracted OFDM signal to generate an RF signal.

Compared to the conventional system the packet converting apparatus can skip the OFDM demodulation process, and the frequency converting apparatus can skip the OFDM demodulation process in the digital broadcast retransmission system of the exemplary embodiment. In this way, the digital broadcast retransmission system of the exemplary embodiment can reduce the weight of the packet converting apparatus and the frequency converting apparatus and speed up the digital broadcast retransmission process.

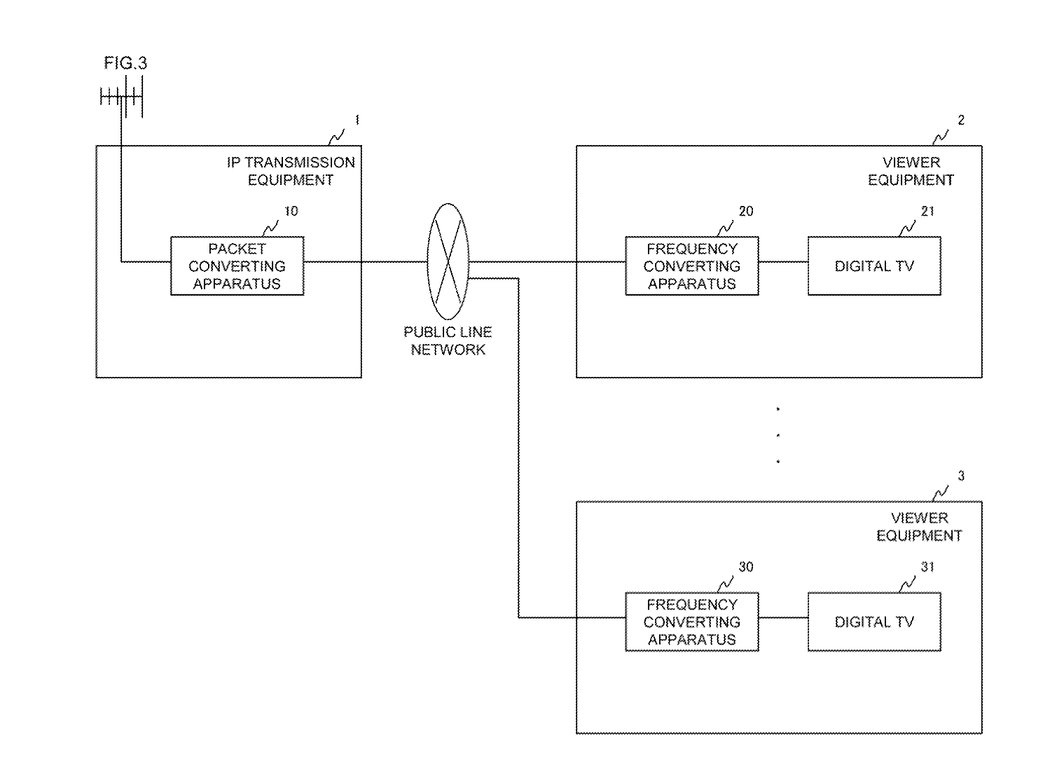

FIG. 3 is a block diagram showing a configuration of the digital broadcast retransmission system of a first exemplary embodiment.

As shown in FIG. 3, the digital broadcast retransmission system of the first exemplary embodiment includes IP transmission equipment 1 and viewer equipment 2 and 3.

Transmission equipment 1 includes packet converting apparatus 10 that converts an RF signal of the terrestrial digital broadcast into an IP packet.

Configurations of viewer equipment 2 and 3 are the same. Therefore, the configuration of viewer equipment 2 will be described representatively.

Viewer equipment 2 includes frequency converting apparatus 20 that converts the IP packet received from packet converting apparatus 10 into an RF signal of the terrestrial digital broadcast and digital TV 21 that converts the RF signal received from frequency converting apparatus 20 into a video signal and a audio signal and that outputs the video signal and the audio signal.

Packet converting apparatus 10 and frequency converting, apparatuses 20 and 30 are connected by a public line network.

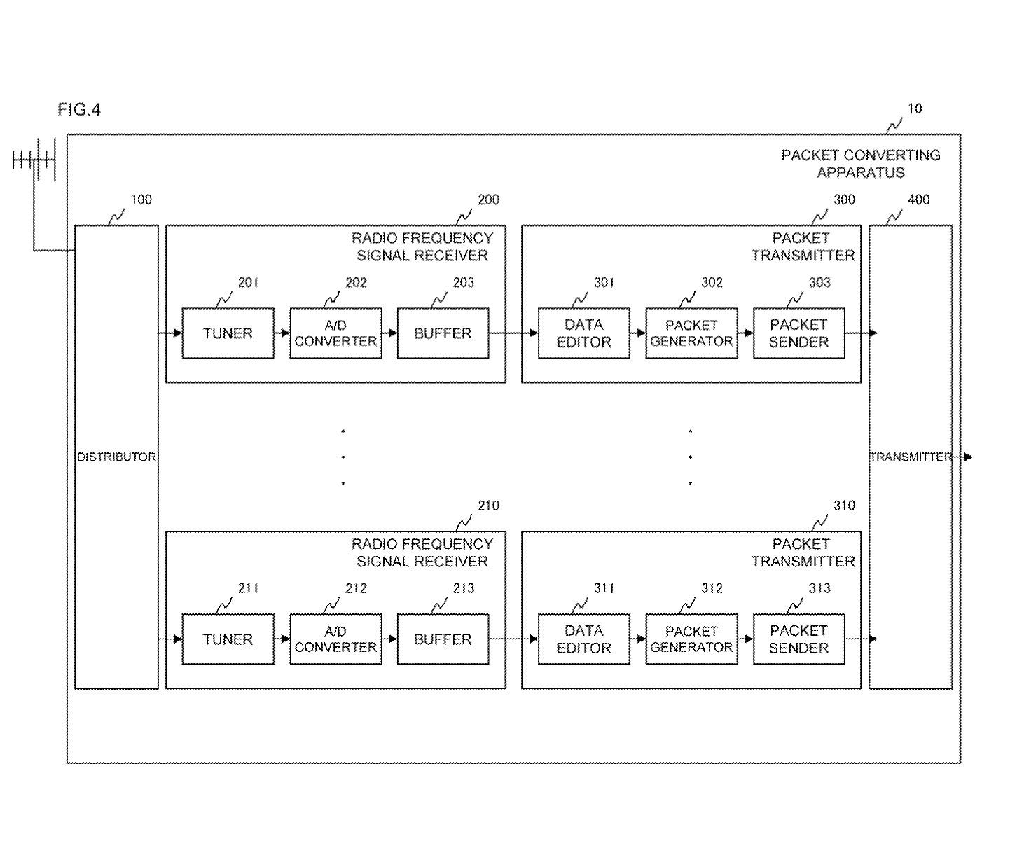

FIG. 4 is a block diagram showing a configuration of the packet converting apparatus of the first exemplary embodiment.

As shown in FIG. 4, packet converting apparatus 10 of the first exemplary embodiment includes distributor 100, radio frequency signal receivers 200 and 210, packet transmitters 300 and 310, and transmitter 400.

Distributor 100 receives an RF signal of a terrestrial digital broadcast broadcasted by a terrestrial digital broadcasting apparatus through a ground wave receiving antenna. Distributor 100 distributes the received RF signal to a tuner of each radio frequency signal receiver.

In packet converting apparatus 10, a radio frequency signal receiver and a packet transmitter that process a signal of a broadcast channel are allocated to each broadcast channel.

Radio frequency signal receivers 200 and 210 process the signals of the allocated broadcast channels, respectively.

Configurations of radio frequency signal receivers 200 and 210 are the same. Therefore, the configuration of radio frequency signal receiver 200 will be described representatively.

Radio frequency signal receiver 200 includes tuner 201, A/D converter 202, and buffer 203.

Tuner 201 demodulates the RF signal received from distributor 100 and extracts the signal of the broadcast channel allocated to timer 201. The broadcast channel allocated to each tuner is set in advance in each tuner. Tuner 201 outputs the signal extracted from the RF signal to A/D converter 202 as a baseband signal.

A/D converter 202 applies A/D conversion to the baseband signal received from tuner 201 to reproduce the OFDM signal OFDM-modulated by the terrestrial digital broadcasting apparatus.

The OFDM signal is a signal, in which processes, such as Reed-Solomon coding, hierarchical division, energy diffusion, byte interleaving, convolutional coding, hierarchical synthesis, time interleaving, and frequency interleaving, are applied to information-source-encoded information, the pilot signal and TMCC signal are attached, IFFT is applied, and a guard interval is attached.

A/D converter 202 outputs the generated OFDM signal to buffer 203.

Buffer 203 includes a FIFO (First-In First-Out) buffer. Buffer 203 temporarily stores the OFDM signal received from A/D converter 202 in the buffer and outputs the stored OFDM signal to data editor 301 of packet transmitter 300 at predetermined intervals.

Packet transmitters 300 and 310 are provided in association with radio frequency signal receivers 200 and 210, respectively, and convert the OFDM signal into an IP packet for each broadcast channel.

Configurations of packet transmitters 300 and 310 are the same. Therefore, the configuration of packet transmitter 300 will be described representatively.

Packet transmitter 300 includes data editor 301, packet generator 302, and packet sender 303.

Data editor 301 divides or combines the OFDM signal received from buffer 203 of radio frequency signal receiver 200 and edits the OFDM signal to an optimal data size for conversion into IP packet. Data editor 301 outputs the edited OFDM signal to packet generator 302.

Packet generator 302 generates an IP packet, in which an IP header describing information such as, IP address, port number, etc. of the destination is attached to the OFDM signal received from data editor 301.

The IP packet is transmitted in multicast in the digital broadcast retransmission system of the exemplary embodiment. The multicast address and the port number, to which the IP packet is transmitted, are allocated to each broadcast channel. The frequency converting apparatus that receives the IP packet can identify the broadcast channel of the received signal based on the received multicast address and port number.

Packet converting apparatus 10 may transmit the IP packet in unicast if the IP packet is individually transmitted to each frequency converting apparatus. In this case, the IP address of the frequency converting apparatus of the destination is the IP address of the destination. Therefore, only a port number, to which the IP packet is transmitted, is allocated to each broadcast channel. The frequency converting apparatus can identify the broadcast channel of the received signal based on the received port number.

An IP address and a port number are set in advance to each packet generator to transmit an OFDM signal of the broadcast channel allocated to the packet generator.

Packet generator 302 outputs the generated IP packet to packet sender 303.

Packet sender 303 sends the IP packet received from packet generator 302 to transmitter 400 at certain intervals.

Transmitter 400 equalizes the IP packets received from the packet senders and transmits the IP packets to the IP network.

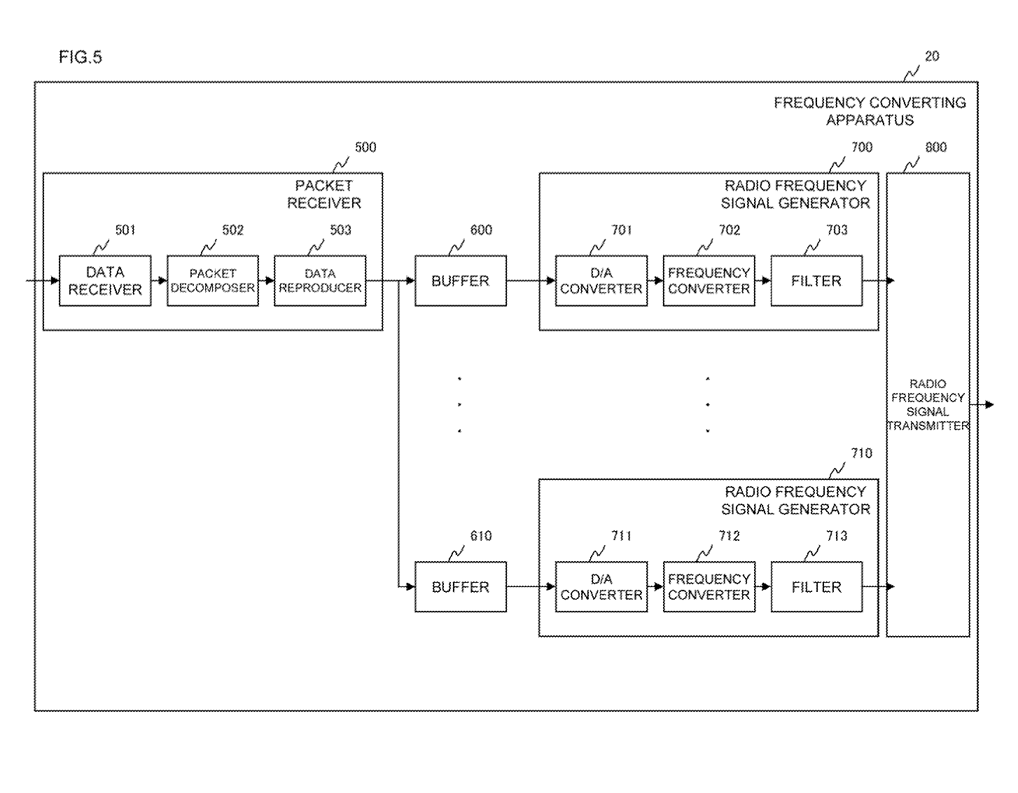

FIG. 5 is a block diagram showing a configuration of the frequency converting apparatus of the first exemplary embodiment.

As shown in FIG. 5, frequency converting apparatus 20 of the first exemplary embodiment includes packet receiver 500, buffers 600 and 610, radio frequency signal generators 700, 710, and radio frequency signal transmitter 800.

Packet receiver 500 includes data receiver 501, packet decomposer 502, and data reproducer 503.

Data receiver 501 receives an IP packet from packet converting apparatus 10. Data receiver 501 identifies the broadcast channel of the signal included in the received IP packet based on the received multicast address and port number. Data receiver 501 transmits the received IP packet and the information of the broadcast channel of the signal included in the IP packet to packet decomposer 502.

Packet decomposer 502 extracts the OFDM signal from the IP packet received from data receiver 501. The extracted OFDM signal is data edited by data editor 301 of packet converting apparatus 10 to an optimal data size for conversion into an IP packet. Packet decomposer 502 outputs the extracted OFDM signal and the information of the broadcast channel of the signal to data reproducer 503.

Data reproducer 503 combines or divides the OFDM signal received from data receiver 501 for each broadcast channel and reconstructs the OFDM signal OFDM-modulated by the terrestrial digital broadcasting apparatus. Data reproducer 503 outputs the reconstructed OFDM signal to the buffer corresponding to each broadcast channel.

A buffer and a radio frequency signal generator that process the signal of the broadcast channel are allocated to each broadcast channel in frequency converting apparatus 20.

Buffers 600 and 610 are allocated to each broadcast channel.

Buffers 600 and 610 include FIFO buffers. Buffers 600 and 610 receive signals of the broadcast channels allocated to buffers 600 and 610 from data reproducer 503 and temporarily store the received OFDM signal in the buffers. Each buffer outputs the stored OFDM signal to a D/A converter of a radio frequency signal generator corresponding to each broadcast channel.

Radio frequency signal generators 700 and 710 are allocated to each broadcast channel. The radio frequency signal generators process signals of the allocated broadcast channels.

Configurations of radio frequency signal generators 700 and 710 are the same. Therefore, the configuration of radio frequency signal generator 700 will be described representatively.

Radio frequency signal generator 700 includes D/A converter 701, frequency converter 702, and filter 703.

D/A converter 701 applies D/A conversion to the OFDM signal received from buffer 600 to generate a baseband signal. D/A converter 701 outputs the generated baseband signal to frequency converter 702.

Frequency converter 702 orthogonally modulates the baseband signal received from D/A converter 701 and further converts the frequency to the frequency of the broadcast channel originally allocated to the baseband signal to generate an RF signal. Frequency converter 702 outputs the generated RF signal to filter 703.

Filter 703 is a bandpass filter that passes through only a specific frequency bandwidth among the inputted signals. Among the RF signals received from frequency converter 702, filter 703 passes through only the frequency bandwidth of the broadcast channel and outputs the signal to radio frequency signal transmitter 800.

Radio frequency signal transmitter 800 receives RF signals outputted in different frequencies from radio frequency signal generators and synthesizes the RF signals of the frequencies. The synthesized RF signal includes a signal of all broadcast channels included in the RF signal of the digital broadcast transmitted by the broadcasting apparatus of the digital broadcast. Radio frequency signal transmitter 800 outputs the synthesized RF signal to a digital TV.

The digital TV receives the RF signal from the frequency converting apparatus and outputs a terrestrial digital broadcast of the broadcast channel selected by a viewer in accordance with an operation of the viewer.

The process by which the packet converting apparatus shown in FIG. 4 converts the RF signal of a terrestrial digital broadcast into an IP packet will be described.

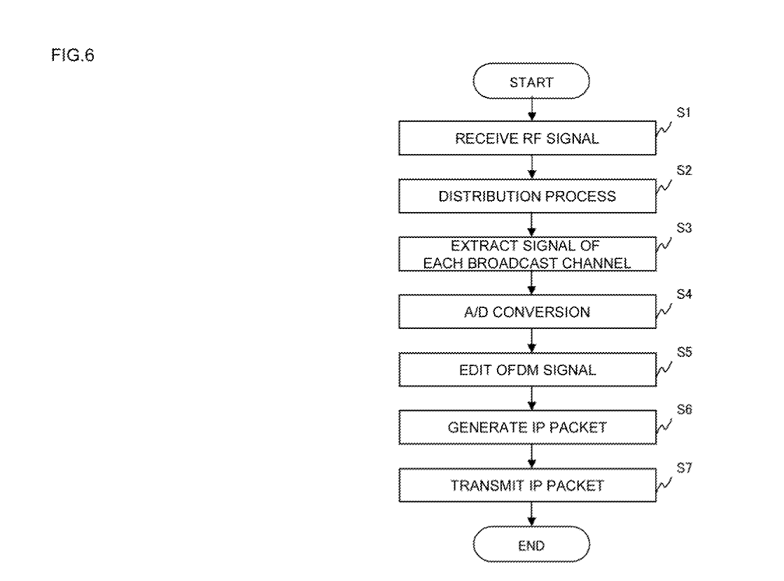

FIG. 6 is a how chart showing a process by which the packet converting apparatus shown in FIG. 4 converts the RF signal of the terrestrial digital broadcast into an IP packet.

Distributor 100 first receives the RF signal of the terrestrial digital broadcast broadcasted by the terrestrial digital broadcasting apparatus through the ground wave receiving antenna (step S1).

When the RF signal of the terrestrial digital broadcast is received, distributor 100 distributes the received RF signal to the tuner of each radio frequency signal receiver (step S2).

When the RF signals are received from distributor 100, tuners 201 and 211 of radio frequency signal receivers 200 and 210 demodulate the received RF signals and extract the signals of the broadcast channels allocated to tuners 201 and 211 (step S3). When the signals of the broadcast channels are extracted, tuners 201 and 211 output the signals extracted from the RF signals to A/D converters 202 and 212 as baseband signals, respectively.

When the baseband signals are received from tuners 201 and 210, A/D converters 202 and 212 apply A/D conversion to the received baseband signals to regenerate the OFDM signals that were OFDM-modulated by the terrestrial digital broadcasting, apparatus (step S4). When the OFDM signals are generated, A/D converters 202 and 212 output the generated OFDM signals to buffers 203 and 213.

When the OFDM signals are received from A/D converters 202 and 212, buffers 203 and 213 temporarily store the received OFDM signals in the buffers and output the stored OFDM signals to data editors 301 and 311 of packet transmitters 300 and 310 at predetermined intervals, respectively.

When the OFDM signals are received from buffers 203 and 213, data editors 301 and 311 divide or combine the received OFDM signals and edit the OFDM signals to an optimal data size for conversion into IP packets (step S5). When the OFDM signals are edited, data editors 301 and 311 output the edited OFDM signals to packet generators 302 and 312, respectively.

When the edited OFDM signals are received from data editors 301 and 311, packet generators 302 and 312 generate IP packets in which IP headers that describe information such as, IP addresses, port numbers, etc. of the destinations are attached to the received OFDM signals (step S6). When the IP packets are generated, packet generators 302 and 312 output the generated IP packets to packet senders 303 and 313.

When the IP packets are received from packet generators 302 and 312, packet senders 303 and 313 send the received IP packets to transmitter 400 at certain intervals.

Transmitter 400 equalizes the IP packets received from packet senders 303 and 313 and transmits the IP packets to the IP network (step S7).

A process by the frequency converting apparatus shown in FIG. 5 to convert the IP packet received from the packet converting apparatus into the RF signal of the terrestrial digital broadcast will be described.

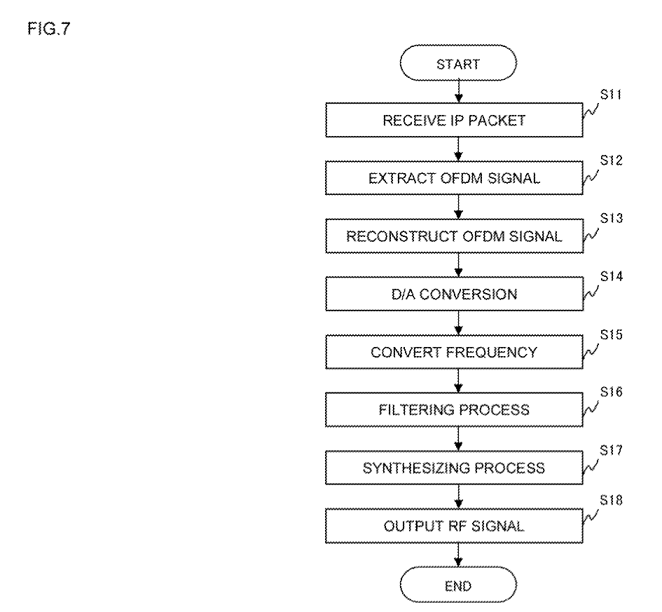

FIG. 7 is a flow chart showing a process by which the frequency converting apparatus shown in FIG. 5 converts the IP packet received from the packet converting apparatus into an RF signal of the terrestrial digital broadcast.

Data receiver 501 of packet receiver 500 first receives the IP packet from packet converting apparatus 10 (step S11). Data receiver 501 identifies the broadcast channel of the signal included in the received IP packet based on the received multicast address and port number. When the broadcast channel of each OFDM signal is identified, data receiver 501 transmits the received IP packet and the information of the broadcast channel of the signal included in the IP packet to packet decomposer 502.

When the IP packet and the information of the broadcast channel of the OFDM signal included in the IP packet are received from data receiver 501, packet decomposer 502 extracts the OFDM signal from the received IP packet (step S12). When the OFDM signal is extracted, packet decomposer 502 outputs the extracted OFDM signal and the information of the broadcast channel of the signal to data reproducer 503.

When the OFDM signal and the information of the broadcast channel of the OFDM signal are received from packet decomposer 502, data reproducer 503 combines or divides the received OFDM signal for each broadcast channel and reconstructs the OFDM signal that were OFDM-modulated by the terrestrial digital broadcasting apparatus (step S13). When the OFDM signal is reconstructed, data reproducer 503 outputs the reconstructed OFDM signal to the buffer corresponding to each broadcast channel.

When the signals of the allocated broadcast channels are received from data reproducer 503, buffers 600 and 610 temporarily store the received OFDM signals in the buffers and output the stored OFDM signals to the D/A converters of the radio frequency signal generator corresponding to the broadcast channels.

When the OFDM signals are received from buffers 600 and 610, D/A converters 701 and 711 apply D/A conversion to the received OFDM signals to generate baseband signals (step S14). When the baseband signals are generated, D/A converters 701 and 711 output the generated baseband signals to frequency converters 702 and 712, respectively.

When the baseband signals are received from D/A converters 701 and 711, frequency converters 702 and 712 orthogonally modulate the received baseband signals and further convert the frequencies of the broadcast channels originally allocated to the baseband signals to generate RF signals (step S15). When the RF signals are generated, frequency converters 702 and 712 output the generated RF signals to filters 703 and 713, respectively.

When the RF signals are received from frequency converters 702 and 712, filters 703 and 713 pass through only the frequency bandwidths of the broadcast channels among the received RF signals and output the RF signals to radio frequency signal transmitter 800 (step S16).

When the RF signals of the frequencies are received from filters 703 and 713, radio frequency signal transmitter 800 synthesizes the RF signal of each frequency (step S17). Radio frequency signal transmitter 800 outputs the synthesized RF signal to the digital TV (step S18).

When the RF signal is received from the frequency converting apparatus, the digital TV outputs a terrestrial digital broadcast of the broadcast channel selected by the viewer in accordance with an operation of the viewer.

As described, according to the exemplary embodiment, the packet converting apparatus extracts transmission-path-encoded information from an RF signal of the digital broadcast, converts the transmission-path-encoded information into an IP packet without restoring the information-source-encoded information, and transmits the IP packet to an IP network. The frequency converting apparatus extracts the transmission-path-encoded information from the IP packet received hem the packet converting apparatus and regenerates the RF signal of the terrestrial digital broadcast from the extracted information.

As a result, the packet converting apparatus does not have to include a circuit for a decoding process of transmission path encoding, and the frequency converting apparatus does not have to include a circuit for coding process of transmission path encoding. Therefore, miniaturization and the cost reduction can be attained. Furthermore, the packet converting apparatus can skip the decoding process of transmission path encoding, and the frequency converting apparatus can skip the coding process of transmission path encoding. Therefore, the amount of time until the terrestrial digital broadcast that is broadcasted from the broadcasting apparatus is reproduced can be reduced.

According to the exemplary embodiment, the packet converting apparatus extracts transmission path encoding information from the RF signal received from the digital broadcasting apparatus for each broadcast channel, converts the transmission path encoding information into an IP packet for each broadcast channel, and transmits the IP packet to an IP network. The frequency converting apparatus regenerates the RF signal of each broadcast channel from the transmission path encoding information and synthesizes the RF signal of each broadcast channel. As a result, the digital broadcast retransmission system can appropriately manage the signal of each broadcast channel.

### Second Exemplary Embodiment

Although the first exemplary embodiment has illustrated an example of digital broadcast retransmission of a terrestrial digital broadcast, the present invention is not limited to this. For example, the present invention can also be used in BS (Broadcasting Satellite) digital broadcasting and 110 east longitude CS (Communications Satellite) digital broadcasting. A second exemplary embodiment illustrates an example of digital broadcast retransmission of a BS digital broadcast and a 110 east longitude CS digital broadcast.

Transmission path encoding is performed by a TC8PSK (Trellis Coded 8 Phase-Shift Keying) modulation system in a BS digital broadcast and a 110 east longitude CS digital broadcast.

Basic configurations of the packet converting apparatus and the frequency converting apparatus are the same as the configurations of the packet converting apparatus and the frequency converting apparatus of the first exemplary embodiment. However, the packet converting apparatus and the frequency converting apparatus correspond to the TC8PSK modulation system.

The radio frequency signal receiver of the packet converting, apparatus demodulates the RF signal of the BS digital broadcast and the 110 east longitude CS digital broadcast, applies A/D conversion to the RF signal, and extracts the information modulated by the TC8PSK modulation system. The packet transmitter of the packet converting apparatus divides or combines the information modulated by the TC8PSK modulation system, edits the information to an optimal data size to convert the information into an IP packet, converts the edited data into an IP packet, and transmits the IP packet.

The packet receiver of the frequency converting apparatus reconstructs the information modulated by the TC8PSK modulation system from the IP packet received from the packet converting apparatus. The radio frequency signal generator of the frequency converting apparatus generates an RF signal of the BS digital broadcast or the 110 east longitude CS digital broadcast from the information modulated by the TC8PSK modulation system and outputs the RF signal to the digital TV.

As a result, the hardware size of the packet converting apparatus and the frequency converting apparatus can be reduced, and the process for digital broadcast retransmission can be reduced in the BS digital broadcast and the 110 east longitude CS digital broadcast in the system of digital broadcast retransmission.

The whole or part of the exemplary embodiments disclosed, above can be described as, but not limited to, the following supplementary notes.

(Supplementary note 1) A digital broadcast retransmission system comprising:
a packet converting apparatus that receives a radio frequency signal broadcasted from a digital broadcasting apparatus, demodulates the radio frequency signal to extract transmission-path-encoded transmission path encoding information from the radio frequency signal, converts the transmission path encoding information into a packet, and transmits the packet to a network; and
a frequency converting apparatus that receives the packet from the packet converting apparatus through the network, extracts the transmission path encoding information from the packet, modulates the transmission path encoding information to generate a radio frequency signal, and transmits the radio frequency signal to a digital broadcast receiving apparatus.

(Supplementary note 2) The digital broadcast retransmission system according to supplementary note 1, wherein
the packet converting apparatus extracts the transmission path encoding information from the radio frequency signal received from the digital broadcasting apparatus for each broadcast channel, converts the transmission path encoding information into a packet for each broadcast channel, and transmits the packet to the network, and
the frequency converting apparatus extracts the transmission path encoding information for each broadcast channel from the packet received from the packet converting apparatus through the network, modulates the transmission path encoding information for each broadcast channel to generate a radio frequency signal, synthesizes the radio frequency signal of each broadcast channel, and transmits the synthesized radio frequency signal to the digital broadcast receiving apparatus.

(Supplementary note 3) The digital broadcast retransmission system according to supplementary note 1 or 2, wherein
the digital broadcasting apparatus is a broadcasting apparatus for terrestrial digital broadcasts, and
the transmission path encoding information is a signal modulated by orthogonal frequency division multiplexing,

(Supplementary note 4) The digital broadcast retransmission system according to supplementary note 1 or 2, wherein
the digital broadcasting apparatus is a broadcasting apparatus for broadcasting satellite digital broadcasts, and
the transmission path encoding information is information modulated by a trellis coded 8 phase-shift keying modulation system.

(Supplementary note 5) The digital broadcast retransmission system according to supplementary note 1 or 2, wherein
the digital broadcasting apparatus is a broadcasting apparatus for communications satellite digital broadcasts, and
the transmission path encoding information is information modulated by the trellis coded 8 phase-shift keying modulation system.

(Supplementary note 6) A digital broadcast retransmission method comprising:
a packet converting apparatus receiving a radio frequency signal broadcasted from a digital broadcasting apparatus and demodulating the radio frequency signal to extract transmission-path-encoded transmission path encoding information from the radio frequency signal;
the packet converting apparatus converting the transmission path encoding information into a packet and transmitting the packet to a network;
a frequency converting apparatus receiving the packet from the packet converting apparatus through the network and extracting the transmission path encoding information from the packet;
the frequency converting apparatus modulating the transmission path encoding information to generate a radio frequency signal; and
the frequency converting apparatus transmitting the radio frequency signal to a digital broadcast receiving apparatus.

(Supplementary note 7) The digital broadcast retransmission method according to supplementary note 6, wherein
the packet converting apparatus extracts the transmission path encoding information from the radio frequency signal received from the digital broadcasting apparatus for each broadcast channel,
the packet converting apparatus converts the transmission path encoding information into a packet for each broadcast channel and transmits the packet to the network,
the frequency converting apparatus extracts the transmission path encoding information for each broadcast channel from the packet received from the packet converting apparatus through the network,
the frequency converting apparatus modulates the transmission path encoding information for each broadcast channel to generate a radio frequency signal, and
the frequency converting apparatus synthesizes the radio frequency signal of each broadcast channel and transmits the synthesized radio frequency signal to the digital broadcast receiving apparatus.

(Supplementary note 8) The digital broadcast retransmission method according to supplementary note 6 or 7, wherein
the digital broadcasting apparatus is a broadcasting apparatus for terrestrial digital broadcasts, and
the transmission path encoding information is a signal modulated by orthogonal frequency division multiplexing.

(Supplementary note 9) The digital broadcast retransmission method according to supplementary note 6 or 7, wherein
the digital broadcasting apparatus is a broadcasting apparatus for broadcasting satellite digital broadcasts, and
the transmission path encoding information is information modulated by a trellis coded 8 phase-shift keying modulation system.

(Supplementary note 10) The digital broadcast retransmission method according to supplementary note 6 or 7, wherein
the digital broadcasting apparatus is a broadcasting apparatus for communications satellite digital broadcasts, and
the transmission path encoding information is information modulated by the trellis coded 8 phase-shift keying modulation system.

(Supplementary note 11) A packet converting apparatus comprising:
radio frequency signal receiver for receiving a radio frequency signal broadcasted from a digital broadcasting apparatus and demodulating the radio frequency signal to extract transmission-path-encoded transmission path encoding information from the radio frequency signal; and
packet transmitter for converting the transmission path encoding information into a packet and transmitting the packet to a network.

(Supplementary note 12) The packet converting apparatus according to supplementary note 11, wherein
the radio frequency signal receiver extracts the transmission path encoding information from the radio frequency signal received horn the digital broadcasting apparatus, and
the packet transmitter converts the transmission path encoding information into a packet for each broadcast channel and transmits the packet to the network.

(Supplementary note 13) A frequency converting apparatus that converts transmission path encoding information transmission-path-encoded by a digital broadcasting apparatus into a packet and that connects to a packet converting apparatus that transmits the packet to a network, the frequency converting apparatus comprising:
packet receiver for receiving the packet from the packet converting apparatus through the network and extracting the transmission path encoding information from the packet;
radio frequency signal generator for modulating the transmission path encoding information to generate a radio frequency signal; and
radio frequency signal transmitter for transmitting the radio frequency signal to a digital broadcast receiving apparatus.

(Supplementary note 14) The frequency converting apparatus according to supplementary note 13, wherein
the packet converting apparatus converts the transmission path encoding information into a packet for each broadcast channel and transmits the packet to the network,
the packet receiver extracts the transmission path encoding information for each broadcast channel from the packet received from the packet converting, apparatus through the network,
the radio frequency signal generator modulates the transmission path encoding information for each broadcast channel to generate a radio frequency signal, and
the radio frequency signal transmitter synthesizes the radio frequency signal for each broadcast channel and transmits the synthesized radio frequency signal to the digital broadcast receiving apparatus.

While the invention has been particularly shown and described with reference to an exemplary embodiment thereof, the invention is not limited to this exemplary embodiment. It will be understood by those ordinarily skilled in the art that various changes in form and details may be made therein without departing from the spirit and scope of the present invention as defined by the claims.

What is claimed is:

1. A digital broadcast retransmission system comprising:
a packet converting apparatus that receives a radio frequency signal broadcasted from a digital broadcasting apparatus, demodulates the radio frequency signal to extract transmission-path-encoded transmission path encoding information from the radio frequency signal, converts the transmission path encoding information into a packet, and transmits the packet to a network; and
a frequency converting apparatus that receives the packet from the packet converting apparatus through the network, extracts the transmission path encoding information from the packet, modulates the transmission path encoding information to generate a radio frequency signal, and transmits the radio frequency signal to a digital broadcast receiving apparatus.

2. The digital broadcast retransmission system according to claim 1, wherein
the packet converting apparatus extracts the transmission path encoding information from the radio frequency signal received from the digital broadcasting apparatus for each broadcast channel, converts the transmission path encoding information into a packet for each broadcast channel, and transmits the packet to the network, and
the frequency converting apparatus extracts the transmission path encoding information for each broadcast channel from the packet received from the packet converting apparatus through the network, modulates the transmission path encoding information for each broadcast channel to generate a radio frequency signal, synthesizes the radio frequency signal of each broadcast channel, and transmits the synthesized radio frequency signal to the digital broadcast receiving apparatus.

3. The digital broadcast retransmission system according to claim 1, wherein
the digital broadcasting apparatus is a broadcasting apparatus for terrestrial digital broadcasts, and
the transmission path encoding information is a signal modulated by orthogonal frequency division multiplexing.

4. The digital broadcast retransmission system according to claim 1, wherein
the digital broadcasting apparatus is a broadcasting apparatus for broadcasting satellite digital broadcasts, and
the transmission path encoding information is information modulated by a trellis coded 8 phase-shift keying modulation system.

5. The digital broadcast retransmission system according to claim 1, wherein
the digital broadcasting apparatus is a broadcasting apparatus for communications satellite digital broadcasts, and
the transmission path encoding information is information modulated by the trellis coded 8 phase-shift keying modulation system.

6. A digital broadcast retransmission method comprising:
a packet converting apparatus receiving a radio frequency signal broadcasted from a digital broadcasting apparatus and demodulating the radio frequency signal to extract transmission-path-encoded transmission path encoding information from the radio frequency signal;
the packet converting apparatus converting the transmission path encoding information into a packet and transmitting the packet to a network;
a frequency converting apparatus receiving the packet from the packet converting apparatus through the network and extracting the transmission path encoding information from the packet;
the frequency converting apparatus modulating the transmission path encoding information to generate a radio frequency signal; and
the frequency converting apparatus transmitting the radio frequency signal to a digital broadcast receiving apparatus.

7. The digital broadcast retransmission method according to claim 6, wherein
the packet converting apparatus extracts the transmission path encoding information from the radio frequency signal received from the digital broadcasting apparatus for each broadcast channel,
the packet converting apparatus converts the transmission path encoding information into a packet for each broadcast channel and transmits the packet to the network,
the frequency converting apparatus extracts the transmission path encoding information for each broadcast channel from the packet received from the packet converting apparatus through the network,
the frequency converting apparatus modulates the transmission path encoding information for each broadcast channel to generate a radio frequency signal, and
the frequency converting apparatus synthesizes the radio frequency signal of each broadcast channel and transmits the synthesized radio frequency signal to the digital broadcast receiving apparatus.

8. The digital broadcast retransmission method according, to claim 6, wherein
the digital broadcasting apparatus is a broadcasting apparatus for terrestrial digital broadcasts, and
the transmission path encoding information is a signal modulated by orthogonal frequency division multiplexing.

9. The digital broadcast retransmission method according to claim 6, wherein
the digital broadcasting apparatus is a broadcasting apparatus for broadcasting satellite digital broadcasts, and
the transmission path encoding information is information modulated by a trellis coded 8 phase-shift keying modulation system.

10. The digital broadcast retransmission method according to claim 6, wherein
the digital broadcasting apparatus is a broadcasting apparatus for communications satellite digital broadcasts, and
the transmission path encoding information is information modulated by the trellis coded 8 phase-shift keying modulation system.

11. A packet converting apparatus comprising:
radio frequency signal receiver for receiving a radio frequency signal broadcasted from a digital broadcasting apparatus and demodulating the radio frequency signal to extract transmission-path-encoded transmission path encoding information from the radio frequency signal; and
packet transmitter for converting the transmission path encoding information into a packet and transmitting the packet to a network.

12. The packet converting apparatus according to claim 11, wherein
the radio frequency signal receiver extracts the transmission path encoding information from the radio frequency signal received from the digital broadcasting apparatus, and
the packet transmitter converts the transmission path encoding information into a packet for each broadcast channel and transmits the packet to the network.
